(19) United States
(12) Patent Application Publication
(10) Pub. No.: US 2013/0186115 A1
(43) Pub. Date: Jul. 25, 2013

(54) LOW GWP HEAT TRANSFER COMPOSITIONS

(71) Applicant: HONEYWELL INTERNATIONAL INC., MORRISTOWN, NJ (US)

(72) Inventors: SAMUEL F. YANA MOTTA, East Amherst, NY (US); MARK W. SPATZ, East Amherst, NY (US); ELIZABET DEL CARMEN VERA BECERRA, Williamsville, NY (US)

(73) Assignee: HONEYWELL INTERNATIONAL INC., MORRISTOWN, NJ (US)

(21) Appl. No.: 13/796,270

(22) Filed: Mar. 12, 2013

Related U.S. Application Data
(63) Continuation-in-part of application No. 13/292,374, filed on Nov. 9, 2011.
(60) Provisional application No. 61/684,883, filed on Aug. 20, 2012.
(60) Provisional application No. 61/413,000, filed on Nov. 12, 2010.

(51) Int. Cl. C09K 5/04

(52) U.S. Cl. CPC C09K 5/044
USPC 62/77; 252/67; 62/498; 62/56; 62/467

(57) ABSTRACT

Heat transfer compositions and methods including (a) HFC-32; (b) HFO-1234ze; and (c) either or both of HFC-152a and/or HFC-134a.

### CROSS REFERENCES TO RELATED APPLICATIONS

The present application claims priority to U.S. Provisional Application Ser. No. 61/684,883, filed Aug. 20, 2012, the contents of which are incorporated herein by reference in its entirety.

This application is also continuation-in-part of U.S. application Ser. No. 13/292,374, filed on Nov. 9, 2011, which claims the priority benefit of U.S. Provisional Application No. 61/413,000, filed on Nov. 12, 2010, the contents each of which are incorporated herein by reference in their entirety.

### FIELD OF THE INVENTION

This invention relates to compositions, methods and systems having utility particularly in refrigeration applications, and in particular aspects to heat transfer and refrigerant compositions useful in systems that typically utilize the refrigerant HCFC-22 for heating and/or cooling applications.

### BACKGROUND

Mechanical refrigeration systems, and related heat transfer devices such as heat pumps and air conditioners, using refrigerant liquids are well known in the art for industrial, commercial and domestic uses. Chlorofluorocarbons (CFCs) were developed in the 1930s as refrigerants for such systems. However, since the 1980s the effect of CFCs on the stratospheric ozone layer has become the focus of much attention. In 1987 a number of governments signed the Montreal Protocol to protect the global environment setting forth a timetable for phasing out the CFC products. CFC's were replaced with more environmentally acceptable materials that contain hydrogen or hydrochlorofluorocarbons (HCFC's). Subsequent amendments to the Montreal protocol accelerated the phase-out of these CFCs and also scheduled the phase-out of HCFCs.

Accordingly, there has thus been an increasing need for new fluorocarbon and hydrofluorocarbon compounds and compositions that are attractive alternatives to the compositions previously used in these and other applications. For example, it has become desirable to retrofit chlorine-containing refrigeration and air conditioning systems by replacing chlorine-containing heat transfer compositions with non-chlorine-containing compounds that will not deplete the ozone layer, such as hydrofluorocarbons (HFC's). Industry in general and the heat transfer industry in particular are continually seeking new fluorocarbon based mixtures that offer alternatives to, and are considered environmentally safer substitutes for, CFCs and HCFCs. It is generally considered important, however, at least with respect to heat transfer fluids, that any potential substitute must also possess those properties present in many of the most widely used fluids, such as excellent heat transfer properties, chemical stability, low- or no-toxicity, low flammability and/or lubricant compatibility, among others. R-22 provides one example of such a refrigerant composition that is used in many refrigeration and air conditioning systems, which is being phased out for the foregoing environmental concerns.

A number of patent publications have suggested replacements for HCFC-22. That is, these patent publications have suggested refrigerant or air conditioning compositions that can be used instead of HCFC-22 in new systems to be built or installed. Among such patent publications include U.S. Pat. No. 5,185,094, U.S. Pat. No. 5,370,811, U.S. Pat. No. 5,438,849, U.S. Pat. No. 5,643,492, U.S. Pat. No. 5,709,092, U.S. Pat. No. 5,722,256, U.S. Pat. No. 6,018,952, U.S. Pat. No. 6,187,219 B1, U.S. Pat. No. 6,606,868 B1, U.S. Pat. No. 6,669,862 B1, published US application no. US 2004/00691091 A1, and published European application nos. EP 0 430169 A1, EP 0 509 673 A1 and EP 0 811 670 A1. While many of these US patents and published applications disclose ternary mixtures of difluoromethane (HFC-32), pentafluoroethane (HFC-125) and tetrafluoroethane (HFC134a) for use in refrigeration or air conditioning systems, none of them address the ability to replace HCFC-22 to obtain a significant reduction of GWP and at the same time similar performance of R-22 without the necessity for modification of the system, especially without the necessity for replacement of the major components (e.g., compressor and expansion valve). In order to replace R-22 in current R-22 AC systems, for example, it is necessary that that the replacement refrigerant operating characteristics, such as evaporator superheat, cooling capacity, refrigerant mass flow rate, efficiency and pressures, are very close to that of the HCFC-22 refrigerant being replaced for the particular heat transfer and other specifications for the existing system. This near match in properties of the replacement refrigerant to those of HCFC-22 in the original system is essential for their use in such existing AC systems or systems designed for using R-22 refrigerant, to prevent equipment replacement or modification, e.g. replacement or modification of expansion valves.

With regard to efficiency, then, it is also important to note that a loss in refrigerant thermodynamic performance or energy efficiency may have secondary environmental impacts through increased fossil fuel usage arising from an increased demand for electrical energy. Thus, it is desirable that the replacement have an equivalent or near equivalent efficiency to R-22.

Furthermore, it is generally considered desirable for CFC and/or HFC refrigerant substitutes to be effective without major engineering changes to conventional vapor compression technology currently used with CFC and/or HFC refrigerants.

Flammability is another important property for many applications. That is, it is considered either important or essential in many applications, including particularly in heat transfer applications, to use compositions which are non-flammable or have only mild flammability. Thus, it is frequently beneficial to use in such compositions compounds which are mildly flammable, or even less flammable than mildly flammable. As used herein, the term “mildly flammable” refers to compounds or compositions which are classified as being 2L in accordance with ASHRAE standard 34 dated 2010, incorporated herein by reference. Unfortunately, many HFC's which might otherwise be desirable for used in refrigerant compositions are flammable and classified as 2 and 3 by ASHRAE. For example, the fluoroalkane difluoroethane (HFC-152a) is flammable A2 and therefore not viable for use in neat form in many applications.

Applicants have thus come to appreciate a need for compositions, and particularly heat transfer compositions that are highly advantageous in vapor compression heating and cooling systems and methods, particularly systems designed for use with R-22.

### SUMMARY

Applicants have found that the above-noted need, and other needs, can be satisfied according to one aspect of the invention by compositions, methods, uses and systems which comprise or utilize a multi-component mixture comprising: (a) HFC-32; (b) greater than 25% of HFO-1234ze, and (c) optionally, but in certain embodiments preferably, HFC-152a and/or HFC-134a. In preferred, but non-limiting, aspects of the present invention, the amounts of each of the components (a), (b) and (c) are selected to ensure that the burning velocity of the composition is less than about 10, the global warming potential of the composition is less than about 500, and the capacity in AC, refrigerant, or heat pump systems is within about 10%, or in further embodiments within about 8%, of the capacity of R-22, particularly, though not exclusively, when tested under heating and/or cooling test conditions identified herein. With regard to the latter, in certain embodiments, the composition has a capacity greater than 95% of R-22 and less than 115% of R-22; in certain embodiments the capacity is greater than 95% of R-22 and less than 110% of R-22; and in further embodiments the capacity is greater than 95% and less than 108% of R-22.

In certain aspects of the foregoing or any embodiment herein, component (b) may further comprise at least one compound selected from unsaturated, —CF3 terminated propenes, unsaturated, —CF3 terminated butenes, and combinations of these, wherein the compound is a compound other than HFO-1234ze.

In further embodiments, compositions of the present invention may include (a) from about 33% to about 55% by weight of HFC-32; and (b) from about 25% to about 66% by weight of HFO-1234ze; and (c) greater than about 0% to about 30% by weight of HFC-152a, HFC-134a, or combinations of these. In further embodiments, the compositions include (a) from about 35% to about 55% by weight of HFC-32; (b) from about 30% to about 55% by weight of HFO-1234ze and (c) from greater than about 0% to about 22% by weight of HFC-152a or greater than about 0% to about 15% by weight of HFC-134a. Unless otherwise indicated herein, the term “% by weight” refers to the weight percent based on the total of the components (a)-(c) in the composition.

In further preferred embodiments, the compositions of the present invention include (a) from about 33% to about 55% by weight of HFC-32; (b) greater than 25% of HFO-1234ze, (c) greater than about 0% to about 25% by weight of HFC-152a; and (d) greater than about 0% to about 20% by weight of HFC-134a, wherein in certain aspects, the total amount of HFC-152a and HFC-134a does not exceed 30% by weight. In further embodiments, the compositions include (a) from about 35% to about 55% by weight of HFC-32; (b) from about 30% to about 55% by weight of HFO-1234ze; (c) greater than about 0% to about 22% by weight of HFC-152a; and (d) greater than about 0% to about 15% by weight of HFC-134a, wherein in certain aspects, the total amount of HFC-152a and HFC-134a does not exceed 30% by weight. Unless otherwise indicated herein, the term “% by weight” refers to the weight percent based on the total of the components (a)-(d) in the composition.

Again, in certain preferred aspects, the heat transfer compositions, methods, uses and systems of the present invention provide a composition with a GWP (as hereinafter defined) of not greater than 500, and even more preferably not greater than about 400, and even more preferably not greater than about 350. The heat transfer compositions, methods, uses and systems of the present invention also preferably provide said composition with ignition hazard level (as hereinafter defined) of not greater than about 7, even more preferably not greater than about 5. It is also generally preferred that the compositions of the present invention have a burning velocity (as hereinafter defined) of not greater than about 10. The heat transfer compositions, methods, uses and systems of the present invention also preferably provide a capacity, particularly in AC, refrigerant, and heat pump systems, that is within about 10%, or in further embodiments within about 8%, of the capacity of R-22. In further embodiments, the composition has a capacity greater than 95% of R-22 and less than 115% of R-22, greater than 95% of R-22 and less than 110% of R-22, or greater than 95% and less than 108% of R-22.

In certain preferred embodiments, component (b) of the present invention comprises, consists essentially of, or consists of HFO-1234ze. The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

### BRIEF DESCRIPTION OF THE FIGURES

FIG. 1 illustrates the burn velocity (BV) of a mixture of HFC-152a and 1234ze(E).

FIG. 2 illustrates the burn velocity (BV) of a mixture of HFC-32 and 1234ze(E).

FIG. 3 illustrates a schematic of the experimental setup for testing of flammable gases.

### DETAILED DESCRIPTION OF PREFERRED EMBODIMENTS

R-22 is commonly used in low temperature refrigeration systems and certain air conditioning systems. It has an estimated Global Warming Potential (GWP) of 1810, which is much higher than is desired or required. Applicants have found that the compositions of the present invention satisfy in an exceptional and unexpected way the need for new compositions for such applications, particularly though not exclusively air conditioning systems, heat pump systems, and commercial refrigeration, having improved performance with respect to environmental impact while at the same time providing other important performance characteristics, such as capacity, efficiency, flammability and toxicity. In preferred embodiments the present compositions provide alternatives and/or replacements for refrigerants currently used in such applications, particularly and preferably HCFC-22, that at once have lower GWP values and provide a refrigerant composition that has a degree of flammability that is mildly flammable or even less flammable than mildly flammable, and which have desirably low toxicity, and preferably also have a close match in cooling capacity to HCFC-22 in such systems.

In certain aspects of the present application, the compositions exhibit a capacity in AC, refrigerant, or heat pump systems within about 10%, or in further embodiments within about 8%, of the heating or cooling capacity of R-22, when tested under heating and cooling test conditions. The term “air conditioning system” or “AC system” refers to any system that cools or heats the air in a given environment. One example of test conditions that may be used to evaluate capacity in such systems is provided in Example 3, below, which measures capacity of a given composition having starting air temperature, starting condenser temperature, starting evaporator temperature, and the like. One of skill in the art, however, will readily appreciate that the present invention is in no way limited to the starting conditions and parameters provided and that the test conditions may be varied in accordance with standard industry practice or otherwise as is known in the art. Non-limiting ranges for a condenser temperature, for example, can be 35° C. to 55° C. for heating and cooling, and non-limiting ranges for an evaporator temperature can be 3° C. to 14° C. for an heating application and −20° C. to 14° C. for a cooling application. One of skill in the art would appreciate that such variation in the test procedures is intended to mimic variation of different environments and the change required of the ambient temperature in a given space.

As mentioned above, the present invention achieves exceptional advantages in connection with commercial refrigeration systems, and in certain preferred aspects stationary refrigeration systems. Non-limiting examples of such stationary refrigeration systems are provided in Examples 4 and 5, below. To this end, such systems may include low temperature commercial applications (Example 6), including commercial freezers or systems that may be used for the storage and maintenance of frozen goods. They may also include medium-temperature commercial application (Example 5), such as commercial refrigerators, including systems for the storage of fresh goods. The examples below provide typical conditions and parameters that are used for such applications. These conditions, however, are not considered limiting to the invention, as one of skill in the art will appreciate that they may be varied based on one or more of a myriad of factors, including but not limited to, ambient conditions, intended application, time of year, and the like. Such examples are also not necessarily limiting to the definition of the terms “stationary refrigeration” or “commercial refrigeration.” The compositions provided herein may be used in similar type systems or, in certain embodiments, in any alternative system where R-22 is or may be adapted for use as a refrigerant.

It is contemplated that in certain embodiments the present invention provides retrofitting methods which comprise replacing at least a substantial portion of the heat transfer fluid (including the refrigerant and optionally the lubricant) in an existing system with a composition of the present invention, without substantial modification of the system. In certain preferred embodiments the replacement step is a drop-in replacement in the sense that no substantial redesign of the system is required and no major item of equipment needs to be replaced in order to accommodate the composition of the present invention as the heat transfer fluid. In certain preferred embodiments, the methods comprise a drop-in replacement in which the capacity of the system is at least about 70%, preferably at least about 85%, even more preferably at least about 90%, and even more preferably at least about 95% of the system capacity prior to replacement, and preferably not greater than about 130%, even more preferably less than about 115%, even more preferably less than about 110%, and even more preferably less than about 105%. In certain preferred embodiments, the methods comprise a drop-in replacement in which the suction pressure and/or the discharge pressure of the system, and even more preferably both, is/are at least about 70%, more preferably at least about 90% and even more preferably at least about 95% of the suction pressure and/or the discharge pressure prior to replacement, and preferably not greater than about 130%, even more preferably less than about 115, even more preferably less than about 110%, and even more preferably less than about 105%. In certain preferred embodiments, the methods comprise a drop-in replacement in which the mass flow of the system is at least about 80%, even more preferably at least 90%, and even more preferably at least 95% of the mass flow prior to replacement, and preferably not greater than about 130%, even more preferably less than about 115, even more preferably less than about 110%, and even more preferably less than about 105%.

### Heat Transfer Compositions

The compositions of the present invention are generally adaptable for use in heat transfer applications, that is, as a heating and/or cooling medium, but are particularly well adapted for use, as mentioned above, in AC systems, heat pumps, and commercial refrigeration, or any other systems that have heretofor used R-22.

Applicants have found that use of the components of the present invention within the stated ranges is important to achieve the important but difficult to achieve combinations of properties exhibited by the present compositions, particularly in the preferred systems and methods, and that use of these same components but substantially outside of the identified ranges can have a deleterious effect on one or more of the important properties of the compositions of the invention.

In certain preferred embodiments, the HFC-32 is present in the compositions of the invention in an amount of from about 33% to about 55% by weight of the compositions.

In certain preferred embodiments, the second component comprises, consists essentially of, of consists of HFO-1234ze, which may be included in amount of about or greater than 25 wt. % or from about 25% to about 66% by weight. In certain preferred aspects, HFO-1234ze comprises, consists essentially of, or consists of trans-HFO-1234ze. This second component may also include one or more additional compounds, other than HFO-1234ze, which may be selected from unsaturated —CF3 terminated propenes, unsaturated —CF3 terminated butenes, and combinations of these, but in further aspects may include one or more additional compounds other than HFO-1234ze.

Compositions of the foregoing may include (a) from about 40% to about 50% by weight of HFC-32; and (b) from about 50% to about 60% by weight of HFO-1234ze. Again, in certain embodiments component (b), comprises, consists essentially of, or consists of HFO-1234ze.

In further preferred embodiments, the compositions of the present invention include HFC-152a in an amount from greater than about 0% to about 25% by weight, or in certain embodiments from greater than about 0% to about 22% by weight. In further embodiments, HFC-152a is provided in an amount from about 1% to about 22% by weight, from about 3% to about 22% by weight, or from about 5% to about 22% by weight. Such compositions may also or alternatively include HFC-134a in an amount greater than about 0% to about 20% by weight, or in certain embodiments from greater than 0% to about 18% by weight. In certain aspects, the composition includes HFC-152a, HFC-134a, or combinations thereof in an amount from greater than 0% by weight to about 30% by weight.

Further compositions of the foregoing may include (a) from about 33% to about 55% by weight of HFC-32; (b) from about 25% to about 66% by weight of HFO-1234ze; and (c) greater than about 0% to about 25% by weight of HFC-152a or HFC-134a. In further embodiments, such compositions include (a) from about 35% to about 55% by weight of HFC-32; (b) from about 30% to about 55% by weight of HFO-1234ze; and (c) greater than about 0% to about 22% by weight of HFC-152a or greater than 0% to about 15% by weight of HFC-134a. As with the foregoing, in certain embodiments, the (b) component in these compositions comprises, consists essentially of, or consists of HFO-1234ze.

In further embodiments, compositions of the foregoing may include (a) from about 33% to about 55% by weight of HFC-32; (b) from about 25% to about 66% by weight of HFO-1234ze; (c) greater than about 0% to about 25% by weight of HFC-152a; and (d) greater than about 0% to about 20% by weight of HFC-134a. In even further embodiments, such compositions include (a) from about 35% to about 55% by weight of HFC-32; (b) from about 20% to about 60% by weight of HFO-1234ze; (c) greater than about 0% to about 22% by weight of HFC-152a; and (d) greater than about 0% to about 15% by weight of HFC-134a. In certain embodiments, the (b) component in these compositions comprises, consists essentially of, or consists of HFO-1234ze.

As mentioned above, applicants have found that the compositions of the present invention are capable of achieving a difficult combination of properties, including low GWP. By way of non-limiting example, the following Table A illustrates the substantial GWP superiority of certain compositions of the present invention, which are described in parenthesis in terms of weight fraction of each component, in comparison to the GWP of HFC-22, which has a GWP of 1810.

TABLE A

| | | | | GWP |
|---|---|---|---|---|
| Group | Name | Composition | GWP | (% R22) |
| Binary Blend | A1 | R32/1234ze(E)(0.4/0.6) | 274 | 15% |
| R32/1234ze | A2 | R32/1234ze(E)(0.45/0.55) | 307 | 17% |
| | A3 | R32/1234ze(E)(0.5/0.5) | 341 | 19% |
| Ternary Blend | B1 | R32/R152a/1234ze(E)(0.45/0.1/0.45) | 319 | 18% |
| R32/1234ze/R152a | B2 | R32/R152a/1234ze(E)(0.45/0.15/0.4) | 325 | 18% |
| | B3 | R32/R152a/1234ze(E)(0.45/0.2/0.35) | 331 | 18% |
| Ternary Blend | C1 | R32/1234ze(E)/R134a(0.45/0.51/0.04) | 364 | 20% |
| | C2 | R32/1234ze(E)/R134a(0.45/0.49/0.06) | 392 | 22% |
| | C3 | R32/1234ze(E)/R134a(0.45/0.47/0.08) | 421 | 23% |
| | C4 | R32/1234ze(E)/R134a(0.45/0.45/0.1) | 449 | 25% |
| | C5 | R32/1234ze(E)/R134a(0.45/0.43/0.12) | 478 | 26% |
| Quaternary Blend | D1 | R32/R152a/1234ze(E)/R134a(0.45/0.05/0.38/0.12) | 484 | 27% |
| R32/1234ze/R152a/R134a | D2 | R32/R152a/1234ze(E)/R134a(0.45/0.1/0.33/0.12) | 490 | 27% |
| | D3 | R32/R152a/1234ze(E)/R134a(0.45/0.15/0.28/0.12) | 496 | 27% |

Applicants have also surprisingly found that in each of the foregoing embodiments of the invention, particularly though not exclusively where component (b) is HFO-1234ze then the burning velocity of the present compositions is substantially linearly related to the weight averaged burning velocity of the components according to the Formula I:

BVcomp=Σ(wt % i·BVi)

where BVcomp is the burning velocity of the composition, and

i is summed for each of the above listed components in the composition, and preferably the amounts of each of the above listed components are selected to ensure that BVcomp based on the finding of this unexpected formula is less than about 10, more preferably less than about 9 and even more preferably less than about 8, while at the same time the GWP of the composition is less than about 500, less than about 400, or more preferably less than about 350.

As also mentioned above, the compositions of the present invention exhibit a degree of hazard value of not greater than about 7. As used herein, degree of hazardousness is measured by observing the results of a cube test using the composition in question and applying a value to that test as indicated by the guidelines provided in the following table below.

HAZARD VALUE GUIDELINE TABLE

| | HAZARD |
|---|---|
| TEST RESULT | VALUE RANGE |
| No ignition). Exemplary of this hazard level | 0 |
| are the pure materials R-134a and transHFO- | |
| 1234ze. | |
| Incomplete burning process and little or no | 1-2 |
| energy imparted to indicator balls and no | |
| substantial pressure rise in the cube (all balls | |
| rise an amount that is barely observable or not | |
| all from the cube holes and essentially no | |
| movement of the cube observed). Exemplary | |
| of this hazard level is the pure material HFO- | |
| 1234yf, with a value of 2. | |
| Substantially complete burning process and | 3-5 |
| low amount of energy imparted to some of the | |
| balls and substantially no pressure rise in the | |
| the cube (some balls rise an observable small | |
| distance and return to the starting position, and | |
| essentially no movement of the cube | |
| observed). ). Exemplary of this hazard level is | |
| the pure material R-32, with a value of 4. | |
| Substantially complete burning process and | 6-7 |
| substantial amount of energy imparted to most | |
| balls and high pressure rise in the cube but | |
| little or no movement of the cube (most balls | |
| rise an observable distance and do not return to | |
| the top of the cube, but little or no movement | |
| of the cube observed). | |
| High Hazard Conditions—Rapid burning and | 8-10 |
| substantial imparted to all balls and substantial | |
| energy imparted to the cube (substantially all | |
| balls rise from the cube and do not return to the | |
| starting position, and substantial movement of | |
| the cube observed). ). Exemplary of this | |
| hazard level are the pure materials R-152a and | |
| R-600a, with values of 8 and 10 respectively. | |

The cube test is conducted as indicated in the Examples below.

The compositions of the present invention may include other components for the purpose of enhancing or providing certain functionality to the composition, or in some cases to reduce the cost of the composition. For example, refrigerant compositions according to the present invention, especially those used in vapor compression systems, include a lubricant, generally in amounts of from about 30 to about 50 percent by weight of the composition, and in some case potentially in amount greater than about 50 percent and other cases in amounts as low as about 5 percent.

Commonly used refrigeration lubricants such as Polyol Esters (POEs) and Poly Alkylene Glycols (PAGs), PAG oils, silicone oil, mineral oil, alkyl benzenes (ABs) and poly(alpha-olefin) (PAO) that are used in refrigeration machinery with hydrofluorocarbon (HFC) refrigerants may be used with the refrigerant compositions of the present invention. Commercially available mineral oils include Witco LP 250 (registered trademark) from Witco, Zerol 300 (registered trademark) from Shrieve Chemical, Sunisco 3GS from Witco, and Calumet R015 from Calumet. Commercially available alkyl benzene lubricants include Zerol 150 (registered trademark). Commercially available esters include neopentyl glycol dipelargonate, which is available as Emery 2917 (registered trademark) and Hatcol 2370 (registered trademark). Other useful esters include phosphate esters, dibasic acid esters, and fluoroesters. In some cases, hydrocarbon based oils have sufficient solubility with the refrigerant that is comprised of an iodocarbon, wherein the combination of the iodocarbon and the hydrocarbon oil are more stable than other types of lubricant. Such combinations are therefore be advantageous. Preferred lubricants include polyalkylene glycols and esters. Polyalkylene glycols are highly preferred in certain embodiments because they are currently in use in particular applications such as mobile air-conditioning. Of course, different mixtures of different types of lubricants may be used.

### Heat Transfer Methods and Systems

The present methods, systems and compositions are thus adaptable for use in connection with a wide variety of heat transfer systems in general and refrigeration systems in particular, such as air-conditioning (including both stationary and mobile air conditioning systems), refrigeration (including commercial refrigeration), heat-pump systems, and the like. In certain preferred embodiments, the compositions of the present invention are used in refrigeration systems originally designed for use with an HCFC refrigerant, such as, for example, R-22. The preferred compositions of the present invention tend to exhibit many of the desirable characteristics of R-22 but have a GWP that is substantially lower than that of R-22 while at the same time having a capacity that is substantially similar to or substantially matches, and preferably is as high as or higher than R-22. In particular, applicants have recognized that certain preferred embodiments of the present compositions tend to exhibit relatively low global warming potentials (“GWPs”), preferably less than about 500, and more preferably not greater than about 400, and even more preferably not greater than about 350.

In certain other preferred embodiments, the present compositions are used in refrigeration systems originally designed for use with R-22. Preferred refrigeration compositions of the present invention may be used in refrigeration systems containing a lubricant used conventionally with R-22, such as polyolester oils, and the like, or may be used with other lubricants traditionally used with HFC refrigerants. As used herein the term “refrigeration system” refers generally to any system or apparatus, or any part or portion of such a system or apparatus, which employs a refrigerant to provide cooling. Such air refrigeration systems include, for example, air conditioners, electric refrigerators, chillers, and the like.

### EXAMPLES

The following examples are provided for the purpose of illustrating the present invention but without limiting the scope thereof.

### Example 1

### Flammability of Mixtures

The burning velocities of common pure component refrigerants are given in the following Table 1.

TABLE 1
Burning velocities of pure components

| | BV, |
|---|---|
| Refrigerant | cm/s |
| HFC-152a | 23 |
| HFC-32 | 6.7 |
| HFC-134a | 0 |
| 1234yf | 1.5 |
| 1234ze(E) | 0 |

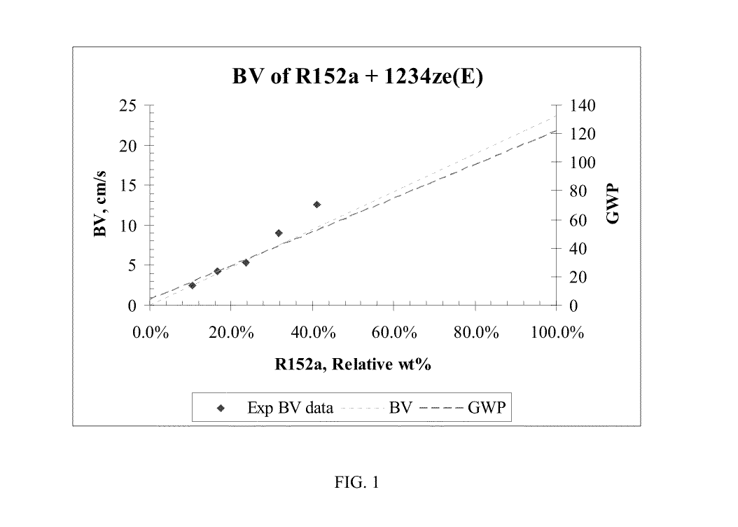

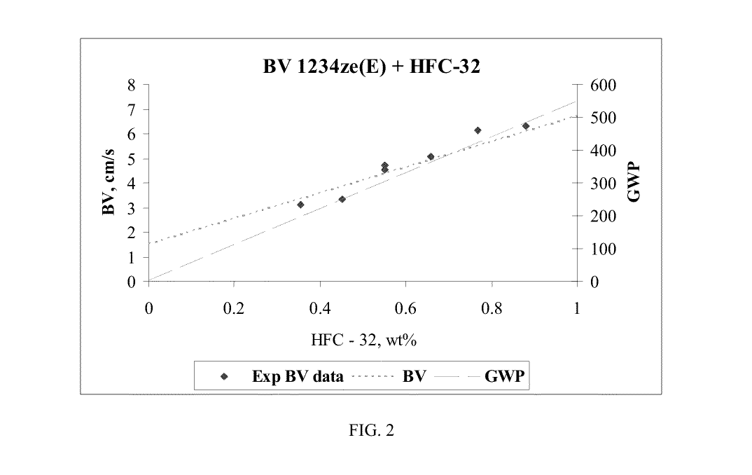

Burning velocity (BV) measurements for certain mixtures HFC-152a/1234ze(E) and HFC-32/1234ze(E) blends are shown in FIGS. 1-2. The burning velocity measurements were performed using the vertical tube method described in ISO standard 817 and ASHRAE standard 34. FIGS. 1-2 also show the GWP of the mixtures. The results in FIGS. 1-2 illustrate applicants' unexpected finding that the maximum burning velocity can closely be approximated by a linear relationship with wt % of the components. According to certain preferred embodiments, therefore, the amount of the components of the present invention is selected according to the Formula I provided above, that is, by approximating the burning velocity of the blends by using the wt % pure component burning velocity. In preferred embodiments, the compositions comprise up to about 30 wt % of HFC-152a, more preferably up to 20% of HFC-152a, while still exhibiting a burning velocity of the blend that is below about 10 cm/s and thus constituting a 2L refrigerant.

For certain HFC-32/HFO-1234ze/HFC-152a blends burning velocity (BV) measurements were performed using the vertical tube method described in ISO standard 817 and ASHRAE standard 34. The results illustrate the unexpected finding that the maximum burning velocity can closely be approximated by a linear relationship with wt % of the components. According to certain preferred embodiments, therefore, the amount of the components of the present invention is selected according to the Formula I provided above, that is, by approximating the burning velocity of the blends by using the wt % pure component burning velocity. In preferred embodiments, the compositions comprise up to about 20 wt % of HFC-152a, while still exhibiting a burning velocity of the blend that is below about 10 cm/s and thus constituting a 2L refrigerant.

As shown in the above data, it has been discovered that the burning velocity of mixtures according to the present invention can be calculated from the wt % times the pure component burning velocity as described in Formula I above

The burning velocities of all the mixtures in Table A were calculated and are shown below in Table 2. All of the mixtures have a burning velocity of less than 10 cm/s and therefore would be expected to be classified as A2L refrigerants.

TABLE 2
Burning velocity of mixtures

| Name | BV (cm/s) |
|---|---|
| A1 | 2.7 |
| A2 | 3.0 |
| A3 | 3.4 |
| B1 | 5.3 |
| B2 | 6.5 |
| B3 | 7.6 |
| C1 | 3.0 |
| C2 | 3.0 |
| C3 | 3.0 |
| C4 | 3.0 |
| C5 | 3.0 |
| D1 | 4.2 |
| D2 | 5.3 |
| D3 | 6.5 |

### Example 2

### Hazard Evaluations

The Cube Test is performed pursuant to the procedure described herein. Specifically, each material being tested is separately released into a transparent cube chamber which has an internal volume of 1 ft³. A low power fan is used to mix components. An electrical spark with enough energy to ignite the test fluids is used. The results of all tests are recorded using a video camera. The cube is filled with the composition being tested so as to ensure a stoichiometric concentration for each refrigerant tested. The fan is used to mix the components. Effort is made to ignite the fluid using the spark generator for 1 min. Record the test using HD camcorder.

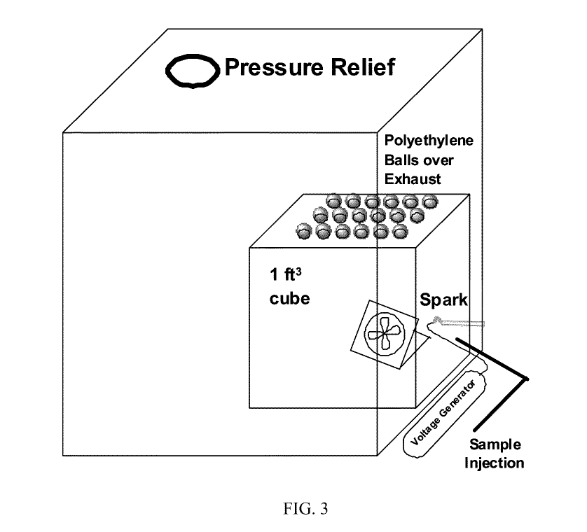

A schematic of the experimental setup for testing of flammable gases is illustrated in FIG. 3.

The Hazardous rating of all the mixtures in Table A were calculated and are shown below in Table 3. All of the mixtures have a hazard rating of less than 7 and therefore would be expected to be safely used in air conditioning systems.

TABLE 3
Hazard Value of mixtures

| Name | Hazard |
|---|---|
| A1 | 3.0 |
| A2 | 3.0 |
| A3 | 3.0 |
| B1 | 4.0 |
| B2 | 5.0 |
| B3 | 6.0 |
| C1 | 2.0 |
| C2 | 2.0 |
| C3 | 2.0 |
| C4 | 2.0 |
| C5 | 2.0 |
| D1 | 4.0 |
| D2 | 4.0 |
| D3 | 5.0 |

With regard to HFC-152a, when used in the one or more compositions herein, it is important in many applications that the amounts of this component be less than about 20% by weight of the composition and preferably less than 15% by weight. This is demonstrated in table 3 where 20% of 152a (B3) get the hazard value of 6 which is very close to safe limit of 7.

### Example 3

### Performance Parameters

The coefficient of performance (COP) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration to the energy applied by the compressor in compressing the vapor. The capacity of a refrigerant represents the amount of cooling or heating it provides and provides some measure of the capability of a compressor to pump quantities of heat for a given volumetric flow rate of refrigerant. In other words, given a specific compressor, a refrigerant with a higher capacity will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988).

Below, an example air conditioning system is provided having the condenser temperature is set to 40.55° C., which generally corresponds to an outdoor temperature of about 35° C. The degree of sub-cooling at the expansion device inlet is set to 5.55° C. The evaporating temperature is set to 7° C., which corresponds to a Indoor ambient temperature of about 20° C. The degree of superheat at evaporator outlet is set to 5.55° C. The degree of superheat in the suction line is set to 10° C., and the compressor efficiency is set to 70%. The pressure drop and heat transfer in the connecting lines (suction and liquid lines) are considered negligible, and heat leakage through the compressor shell is ignored. Several operating parameters are determined for the compositions identified in Table A above in accordance with the present invention, and these operating parameters are reported in Table 4 below, based upon R-22 having a COP value of 1.00, a capacity value of 1.00 and a discharge temperature of 83.06° C.

In certain preferred embodiments the replacement should not require substantial redesign of the system and no major item of equipment needs to be replaced in order to accommodate the refrigerant of the present invention. For that purpose the replacement preferably fulfills one or more of, and preferably all, of the following requirements:
High-Side Pressure that is within about 115%, and even more preferably within about 110% of the high side pressure of the same system using R-22. This parameter can be important in such embodiments because it can enhance the ability to use existing pressure components in such systems.
Discharge Temperature that is ±5° C. of R22. One advantage of such a characteristic is that it can permit the use of existing equipment without activation of the thermal protection aspects of the system, which are preferably designed to protect compressor components. This parameter is also advantageous in that it can help to avoid the use of costly controls such as liquid injection to reduce discharge temperature.
Cooling capacity that is within +115% (preferably 110%) and 95% of the cooling capacity of the same system using R-22. This parameter is potentially important in certain embodiments because it can help to ensure adequate cooling of the product being refrigerated. It should also be noted that excess capacity can cause overload of the electric motor therefore they should be also avoided.
Efficiency (COP) that is similar to R-22 (±5%) without incurring in excess capacity as noted above.
Maintains degree of superheat of at least +1° C., preferably +3° C. If degrees of superheat lower than 1° C. are used, there is a risk liquid floodback to the compressor.
The blend is a 2L class refrigerant with a BV less than 10 cm/s
The GWP is lower than 500, preferably less than 400, and even less than 350 for some of the proposed blends.

TABLE 4

| | | | | | | Diff | | |
|---|---|---|---|---|---|---|---|---|
| | | | | | | Dis. | | Degree of |
| | | | | Suction | Discharge | Temp. | Rel- | Superheat, |
| Group | Name | Capacity | Efficiency | Pressure | Press. | ° C. | Flow | ° C. |
| Binary Blend | A1 | 101% | 98% | 99% | 104% | −0.7 | 87% | 0.7 |
| R32/1234ze | A2 | 106% | 98% | 105% | 110% | 0.7 | 90% | 2.7 |
| | A3 | 111% | 97% | 111% | 115% | 2.0 | 91% | 4.7 |
| Ternary Blend | B1 | 105% | 98% | 102% | 107% | 1.8 | 84% | 2.2 |
| R32/1234ze/R152a | B2 | 105% | 99% | 101% | 106% | 2.4 | 81% | 1.9 |
| | B3 | 104% | 99% | 100% | 105% | 2.9 | 78% | 1.6 |
| Ternary Blend | C1 | 107% | 98% | 105% | 110% | 0.7 | 90% | 3.0 |
| R32/1234ze/R134a | C2 | 107% | 98% | 105% | 110% | 0.7 | 90% | 3.2 |
| | C3 | 108% | 98% | 106% | 111% | 0.7 | 90% | 3.3 |
| | C4 | 108% | 98% | 106% | 111% | 0.8 | 90% | 3.5 |
| | C5 | 108% | 98% | 106% | 111% | 0.8 | 90% | 3.6 |
| Quaternary Blend | D1 | 107% | 98% | 105% | 110% | 1.4 | 87% | 3.2 |
| R32/1234ze/R152a/ | D2 | 106% | 98% | 104% | 109% | 2.1 | 84% | 2.8 |
| R134a | D3 | 106% | 99% | 102% | 107% | 2.7 | 81% | 2.4 |

As can be seen from the Table 4 above, applicants have found that the compositions of the present invention are capable of at once achieving many of the important refrigeration system performance parameters close to the parameters for R-22, and in particular sufficiently close to permit such compositions to be used as replacement for R-22 in low temperature refrigeration systems and/or for use in such existing systems with only minor system modification.

As demonstrated above, compositions exhibit capacities in this low temperature refrigeration system that are within about 8% of the capacity in such system of R-22. As also demonstrated, all blends tested exhibited acceptable performance being the preferred due to the fulfillment of all requirements.

Since many existing Air conditioning systems have been designed for R-22 those skilled in the art will appreciate the substantial advantage of a refrigerant with low GWP and superior efficiency which can be used as replacement for R-22 or like refrigerants with relatively minimal modifications to the system. Furthermore, those skilled in the art will appreciate that the present compositions are capable of providing substantial advantage for use in new or newly designed refrigeration systems, including preferably, air conditioning systems.

### Example 4

### Sensitivity Analysis

Using the same operating conditions of example 3, we generated data for lower and higher amounts of R32 as shown in table 5. For each group, we took a representative mixture (A2, B2, C2 and D2) and increased/decreased the contents of R32 until one of the environmental of performance parameters are out of the preferred range (see example 3).

TABLE 5

| | | | | GWP |
|---|---|---|---|---|
| Group | Name | Composition | GWP | (% R22) |
| Binary Blend | A2-Low | R32/1234ze(E)(0.34/0.66) | 233 | 13% |
| R32/1234ze | A2 | R32/1234ze(E)(0.45/0.55) | 307 | 17% |
| | A2-High | R32/1234ze(E)(0.55/0.45) | 374 | 21% |
| Ternary Blend | B2-Low | R32/R152a/1234ze(E)(0.35/0.15/0.5) | 258 | 14% |
| R32/1234ze/R152a | B2 | R32/R152a/1234ze(E)(0.45/0.15/0.4) | 325 | 18% |
| | B2-High | R32/R152a/1234ze(E)(0.55/0.15/0.3) | 392 | 22% |
| Ternary Blend | C2-Low | R32/1234ze(E)/R134a(0.33/0.61/0.06) | 312 | 17% |
| R32/1234ze/R134a | C2 | R32/1234ze(E)/R134a(0.45/0.49/0.06) | 392 | 22% |
| | C2-High | R32/1234ze(E)/R134a(0.55/0.39/0.06) | 459 | 25% |
| Quaternary Blend | D2-Low | R32/R152a/1234ze(E)/R134a(0.33/0.1/0.45/0.12) | 409 | 23% |
| R32/1234ze/R152a/ | D2 | R32/R152a/1234ze(E)/R134a(0.45/0.1/0.33/0.12) | 490 | 27% |
| R134a | D2-High | R32/R152a/1234ze(E)/R134a(0.55/0.1/0.23/0.12) | 557 | 31% |

TABLE 6

| Name | BV (cm/s) |
|---|---|
| A2-Low | 2.3 |
| A2 | 3.0 |
| A2-High | 3.7 |
| B2-Low | 5.8 |
| B2 | 6.5 |
| B2-High | 7.1 |
| C2-Low | 2.2 |
| C2 | 3.0 |
| C2-High | 3.7 |
| D2-Low | 4.5 |
| D2 | 5.3 |
| D2-High | 6.0 |

TABLE 7

| Name | Hazard |
|---|---|
| A2-Low | 3.0 |
| A2 | 3.0 |
| A2-High | 3.0 |
| B2-Low | 5.0 |
| B2 | 5.0 |
| B2-High | 5.0 |
| C2-Low | 2.0 |
| C2 | 2.0 |
| C2-High | 2.0 |
| D2-Low | 4.0 |
| D2 | 4.0 |
| D2-High | 4.0 |

When it comes to BV and hazard level, the amount of R32 or 1234ze does not impose any special limitation (tables 6 and 7).

TABLE 8

| | | | | | | Diff | | |
|---|---|---|---|---|---|---|---|---|
| | | | | | | Discharge | | Deg. |
| | | | | Suction | Dis. | Temperature, | Rel- | Suprheat, |
| Group | Name | Cap. | Eff. | Press. | Press. | ° C. | Flow | ° C. |
| Binary Blend | A2-Low | 95% | 99% | 91% | 97% | −2.5 | 85% | −1.7 |
| R32/1234ze | A2 | 106% | 98% | 105% | 110% | 0.7 | 90% | 6.5 |
| | A2- | 116% | 97% | 116% | 120% | 3.3 | 93% | 4.7 |
| | High | | | | | | | |
| Ternary Blend | B2-Low | 95% | 100% | 90% | 96% | −0.7 | 77% | −1.6 |
| R32/1234ze/R152a | B2 | 105% | 99% | 101% | 106% | 2.4 | 81% | 1.9 |
| | B2- | 114% | 98% | 112% | 116% | 5.2 | 84% | 5.2 |
| | High | | | | | | | |
| Ternary Blend | C2-Low | 95% | 99% | 91% | 97% | −2.8 | 85% | −1.6 |
| R32/1234ze/R134a | C2 | 107% | 98% | 105% | 110% | 0.7 | 90% | 3.2 |
| | C2- | 117% | 97% | 117% | 121% | 3.4 | 94% | 6.9 |
| | High | | | | | | | |
| Quaternary Blend | D2-Low | 95% | 100% | 90% | 96% | −1.7 | 80% | −1.4 |
| R32/1234ze/R152a/ | D2 | 106% | 98% | 104% | 109% | 2.1 | 84% | 2.8 |
| R134a | D2- | 116% | 98% | 114% | 118% | 4.9 | 87% | 6.1 |
| | High | | | | | | | |

Binary Blends of R32/1234ze have a preferred GWP of less than 350 so we chose A2 to perform this analysis. At the low R32 limit, we notice that the capacity is at the limit of the preferred value (95%). We also get no degree of superheat when using the same expansion device. For the high range of R32, we get an excess of capacity (116%) which can cause electric motor overload. Moreover, the GWP of this blend is 374 which exceeds the preferred limit of 350 (table 5).

Ternary Blends of R32/1234ze/R152a have a preferred GWP of less than 350 so we chose B2 to perform this analysis. At the low R32 limit, we notice that the capacity is at the limit of the preferred value (95%). We also get no degree of superheat when using the same expansion device. For the high range of R32, we get an excess of capacity (114%) which can cause electric motor overload. Moreover, the GWP of this blend is 392 which exceeds the preferred limit of 350 (table 5).

Ternary Blends of R32/1234ze/R134a have a preferred GWP of less than 400 so we chose C2 to perform this analysis. At the low R32 limit, we notice that the capacity is at the limit of the preferred value (95%). We also get no degree of superheat when using the same expansion device. For the high range of R32, we get an excess of capacity (117%) which can cause electric motor overload. Moreover, the GWP of this blend is 459 which exceeds the preferred limit of 400 (table 5).

Quaternary Blends of R32/1234ze/R152a/R134a have a preferred GWP of less than 500 so we chose D2 to perform this analysis. At the low R32 limit, we notice that the capacity is at the limit of the preferred value (95%). We also get no degree of superheat when using the same expansion device. For the high range of R32, we get an excess of capacity (116%) which can cause electric motor overload. Moreover, the GWP of this blend is 557 which exceeds the preferred limit of 500 (table 5).

### Example 5

### Performance in Stationary Refrigeration (Commercial Refrigeration)—Medium Temperature Applications

The performance of some preferred compositions were evaluated against other refrigerant compositions at conditions typical of medium temperature refrigeration. This application covers the refrigeration of fresh food. The conditions at which the compositions were evaluated are shown in Table 9:

TABLE 9

| | |
|---|---|
| Evaporating Temperature | 20° F. (−6.7° C.) |
| Condensing Temperature | 110° F. (43.3° C.) |
| Evaporator Superheat | 10° F. (5.5° C.) |
| Condenser Subcooling | 9° F. (5° C.) |
| Compressor Displacement | 1.0 ft³/min (0.028 m³/min) |
| Compressor Isentropic Eff. | 65% |
| Compressor Return Temp | 45° F. (7.2° C.) |

Table 10 compares compositions of interest to the baseline refrigerant, R-22 in typical medium temperature application.

TABLE 10

| | | | | | | Diff Dis. | | Degree of |
|---|---|---|---|---|---|---|---|---|
| | | | | Suction | Discharge | Temp. | | Superheat, |
| Group | Name | Capacity | Efficiency | Pressure | Press. | ° C. | Rel-Flow | ° C. |
| Binary Blend | A1 | 97% | 97% | 96% | 104% | −4 | 84% | 0.0 |
| R32/1234ze | A2 | 103% | 97% | 102% | 110% | −2 | 87% | 1.9 |
| | A3 | 108% | 97% | 108% | 115% | 1 | 89% | 3.7 |
| Ternary Blend | B1 | 102% | 98% | 100% | 108% | 0 | 81% | 1.5 |
| R32/1234ze/R152a | B2 | 101% | 98% | 99% | 106% | 1 | 78% | 1.2 |
| | B3 | 101% | 98% | 97% | 105% | 2 | 76% | 1.0 |
| Ternary Blend | C1 | 103% | 97% | 102% | 110% | −2 | 87% | 2.2 |
| R32/1234ze/R134a | C2 | 104% | 97% | 103% | 111% | −2 | 87% | 2.4 |
| | C3 | 104% | 97% | 103% | 111% | −1 | 87% | 2.5 |
| | C4 | 104% | 97% | 103% | 111% | −1 | 88% | 2.7 |
| | C5 | 104% | 97% | 104% | 111% | −1 | 88% | 2.8 |
| Quaternary | D1 | 104% | 98% | 102% | 110% | 0 | 85% | 2.5 |
| Blend | D2 | 103% | 98% | 101% | 109% | 1 | 81% | 2.1 |
| R32/1234ze/R152a/ | D3 | 103% | 98% | 99% | 108% | 2 | 79% | 1.7 |
| R134a | | | | | | | | |

As can be seen, the compositions are within 5% of the efficiency of the baseline refrigerant, R-22 and within 5% of the capacity.

### Example 6

### Performance in Stationary Refrigeration (Commercial Refrigeration)—Low Temperature Applications

The performance of some preferred compositions were evaluated against other refrigerant compositions at conditions typical of low temperature refrigeration. This application covers the refrigeration of frozen food. The conditions at which the compositions were evaluated are shown in Table 11:

TABLE 11

| | |
|---|---|
| Evaporating Temperature | −15° F. (−26.1° C.) |
| Condensing Temperature | 110° F. (43.3° C.) |
| Evaporator Superheat | 10° F. (5.5° C.) |
| Condenser Subcooling | 9° F. (5° C.) |
| Compressor Displacement | 1.0 ft³/min (0.028 m³/min) |
| Compressor Isentropic Eff. | 65% |
| Compressor Return Temp | 30° F. (−1.1° C.) |

Table 12 compares compositions of interest to the baseline refrigerant, R-22 in typical low temperature application.

TABLE 12

| | | | | | | Diff | | |
|---|---|---|---|---|---|---|---|---|
| | | | | | | Dis. | | Degree of |
| | | | | Suction | Discharge | Temp. | | Superheat, |
| Group | Name | Capacity | Efficiency | Pressure | Press. | ° C. | Rel-Flow | ° C. |
| Binary Blend | A1 | 91% | 96% | 91% | 104% | −10 | 80% | −0.7 |
| R32/1234ze | A2 | 98% | 96% | 98% | 110% | −5 | 83% | 0.9 |
| | A3 | 104% | 96% | 104% | 115% | −1 | 86% | 2.6 |
| Ternary Blend | B1 | 97% | 97% | 96% | 108% | −2 | 78% | 0.7 |
| R32/1234ze/R152a | B2 | 97% | 98% | 95% | 106% | 0 | 75% | 0.5 |
| | B3 | 96% | 98% | 93% | 105% | 1 | 72% | 0.3 |
| Ternary Blend | C1 | 98% | 96% | 98% | 110% | −5 | 83% | 1.3 |
| R32/1234ze/R134a | C2 | 99% | 96% | 99% | 111% | −5 | 84% | 1.4 |
| | C3 | 99% | 96% | 99% | 111% | −5 | 84% | 1.5 |
| | C4 | 99% | 96% | 99% | 111% | −5 | 84% | 1.7 |
| | C5 | 100% | 96% | 100% | 111% | −4 | 84% | 1.8 |
| Quaternary | D1 | 99% | 97% | 98% | 110% | −3 | 81% | 1.6 |
| Blend | D2 | 99% | 97% | 97% | 109% | −1 | 78% | 1.3 |
| R32/1234ze/R152a/ | D3 | 98% | 98% | 95% | 108% | 1 | 75% | 1.0 |
| R134a | | | | | | | | |

As can be seen, the compositions are within 5% of the efficiency of the baseline refrigerant, R-22 and within 10% of the capacity.

What is claimed is:

1. A heat transfer composition comprising:
(a) from about 33% to about 55% by weight of HFC-32;
(b) at least about 25% by weight of HFO-1234ze; and
(c) from greater than about 0% to about 30% by weight of HFC-152a, HFC-134a, and combinations of these, provided that the amount of each of the components (a), (b) and (c) is selected to ensure that the burning velocity of the composition is less than about 10, the global warming potential of the composition is less than about 500, and the capacity is within about 10% of the cooling capacity of R-22 in an R-22-containing system.

2. The heat transfer composition of claim 1, wherein said component (b) further comprises at least one compound, other than HFO-1234ze, selected from unsaturated —CF3 terminated propenes, unsaturated —CF3 terminated butenes, and combinations of these.

3. The heat transfer composition of claim 1, comprising from about 33% to about 55% by weight of HFC-32; from about 25% to about 66% by weight of HFO-1234ze; and from greater than about 0% to about 25% by weight of HFC-152a.

4. The heat transfer composition of claim 3, comprising from about 35% to about 55% by weight of HFC-32; from about 30 to about 55% by weight of HFO-1234ze; and from greater than about 0% to about 22% by weight of HFC-152a.

5. The heat transfer composition of claim 4 comprising from about 35% to about 55% by weight of HFC-32; from about 30 to about 55% by weight of HFO-1234ze; and from about 5% to about 22% by weight of HFC-152a.

6. The heat transfer composition of claim 1 comprising from about 33% to about 55% by weight of HFC-32; from about 45 to about 66% by weight of HFO-1234ze; and from greater than about 0% to about 20% by weight of HFC-134a.

7. The heat transfer composition of claim 1 comprising from about 33% to about 55% by weight of HFC-32; component; from about 25 to about 66% by weight of HFO-1234ze; from greater than about 0% to about 20% by weight HFC-134a and from greater than about 0% to about 25% by weight HFC-152a, wherein the total amount of both HFC-134a and HFC-152a is not greater than about 30% by weight.

8. A heat transfer composition comprising:
(a) from about 33% to about 55% by weight of HFC-32;
(b) from about 25% to about 66% by weight of HFO-1234ze; and
(c) from greater than about 0% to about 25% by weight of HFC-152a or HFC-134a wherein the burning velocity of the compositions is less than about 10 and is substantially linearly related to the weight averaged burning velocity of the components.

9. The heat transfer composition of claim 8, wherein said component (b) further comprises at least one compound, other than HFO-1234ze, selected from unsaturated —CF3 terminated propenes, unsaturated —CF3 terminated butenes, and combinations of these.

10. The heat transfer composition of claim 8 comprising from about 33% to about 55% by weight of HFC-32; from about 25 to about 66% by weight of HFO-1234ze; and from greater than about 0% to about 25% by weight of HFC-152a.

11. The heat transfer composition of claim 8 comprising from about 35% to about 55% by weight of HFC-32; from about 30 to about 55% by weight of HFO-1234ze; and from greater than about 0% to about 22% by weight of HFC-152a.

12. The heat transfer composition of claim 8 comprising from about 35% to about 55% by weight of HFC-32; from about 30 to about 55% by weight of HFO-1234ze; and from about 5% to about 22% by weight of HFC-152a.

13. A heat transfer composition comprising:
(a) from about 33% to about 55% by weight of HFC-32;
(b) at least about 25% by weight of HFO-1234ze;
(c) from greater than about 0% to about 25% by weight of HFC-152a; and
(d) from greater than about 0% to about 20% by weight of HFC-134a
wherein a total amount of HFC-152a and HFC-134a does not exceed 30% by weight, and the burning velocity of the compositions is less than about 10 and is substantially linearly related to the weight averaged burning velocity of the components.

14. A heat transfer composition comprising:
(a) from about 33% to about 55% by weight of HFC-32;
(b) at least about 25% by weight of HFO-1234ze;
(c) from greater than about 0% to about 25% by weight of HFC-152a; and
wherein the burning velocity of the compositions is less than about 10 and is substantially linearly related to the weight averaged burning velocity of the components.

15. The heat transfer composition of claim 14 comprising from greater than about 0% to about 22% by weight of HFC-152a.

16. The heat transfer composition of claim 14 comprising from about 5% to about 22% by weight of HFC-152a.

17. A method of replacing an existing heat transfer fluid contained in heat transfer system comprising removing at least a portion of said existing heat transfer fluid from said system, said existing heat transfer fluid being HFC-22 and replacing at least a portion of said existing heat transfer fluid by introducing into said system a heat transfer composition of claim 1.

18. A heat transfer system comprising a compressor, a condenser and an evaporator in fluid communication, and a heat transfer composition in said system, said heat transfer composition comprising the composition of claim 1.

19. The heat transfer system of claim 18 wherein said heat transfer system is selected from the group consisting of air conditioning systems, commercial refrigeration systems, heat pump systems, and combinations of two or more of these.

20. A method of transferring heat to or from a fluid or body comprising causing a phase change in a composition of claim 1, and exchanging heat with said fluid or body during said phase change.

21. A refrigeration system comprising a composition in accordance with claim 1, said system being selected from the group consisting of air conditioning systems, commercial refrigerator systems, heat pump systems, and combinations of two or more of these.
